(19) United States
(12) Patent Application Publication
(10) Pub. No.: US 2010/0283711 A1
(43) Pub. Date: Nov. 11, 2010

(54) AN INTEGRATED COMPUTATION AND COMMUNICATION SYSTEM, A FRAMED INTERFACE THEREFOR AND A METHOD OF OPERATING THEREOF

(75) Inventor: Lloyd W. Sadler, Allentown, PA (US)

Correspondence Address: HITT GAINES, PC;LSI Corporation, PO BOX 832570, RICHARDSON, TX, 75083, US

(73) Assignee: LSI Corporation, Milpitas, CA (US)

(21) Appl. No.: 12/435,404

(22) Filed: May 5, 2009

(51) Int. Cl. G09G 5/00; G06F 17/00

(52) U.S. Cl. 345/8; 700/94

(57) ABSTRACT

An integrated computational and communication system having modular components, a framed user interface and a method of operation an integrated computational and communication system are provided. In one embodiment, the integrated computational and communication system includes: (1) an input component configured to receive input data from a user, (2) an output component configured to provide output data to the user, (3) a controller configured to provide computational functionality and telephone communication for the system and (4) a communication base station configured to provide bi-directional communication channels between the input and output components, the communication base station and the controller, wherein the communication base station and the controller are adapted to be worn by the user.

### TECHNICAL FIELD

This application is directed, in general, to communication and computer systems and, more specifically, to personal communication and computer systems.

### BACKGROUND

With technological advancements, computational tasks are increasingly being performed in collaborative environments having different communication systems that communicate therebetween. Additionally, computational tasks are being performed in different locations as opposed to a fixed office location having a work station environment with a traditional computer. Furthermore, the interaction between computation and communication is becoming blurred, blended and merged, such that a computer is expected to be able to provide data communications with other computer devices.

A laptop or notebook computer is typically capable of substantial computation and of wireless communication with other similarly equipped computational devices. Nevertheless, such typical portable computers (1) are too large to be routinely carried by a user; (2) have displays that are either too small to be convenient or too large to be easily portable; (3) may not be capable of easily establishing local area networks with other devices without requiring the use of additional “hub” hardware and/or software; (4) require the use of fixed form input devices (e.g., a keyboard, a mouse or a touch pad) that may limit portability if full size and, if a compact size, may limit ease of use, associated productivity and can cause hand or wrist strain; and (5) do not provide telephone-type voice communication (e.g., voice communication via a cellular network).

Cellular telephones and the like, which are typically highly portable voice communication devices and which may include the capability to send or receive e-mail and even to play music and video games, are nevertheless not fully operative computational devices. Additionally, cellular telephones typically have very limited display and storage capability and are not typically able to perform complex general purpose computation, such as word, data and image processing. Furthermore, such existing cellular telephones are not typically able to network with other like devices without the use of intervening cellular equipment.

### SUMMARY

One aspect provides an integrated computational and communication system having modular components. In one embodiment, the system includes: (1) an input component configured to receive input data from a user, (2) an output component configured to provide output data to the user, (3) a controller configured to provide computational functionality and telephone communication for the system and (4) a communication base station configured to provide bi-directional communication channels between the input and output components, the communication base station and the controller, wherein the communication base station and the controller are adapted to be worn by the user.

In another aspect, a framed user interface is provided. In one embodiment, the framed user interface includes: (1) a head-mountable frame, (2) at least one infinity optics display attached to the frame, (3) at least one audio output device attached to the frame, (4) a microphone attached to the frame, (5) a communication channel interface attached to the frame and configured to provide communication channels for transmitting input audio data from the microphone and receiving video data for the at least one infinity optics display and output audio data for the at least one audio output device and (6) an audio and video controller attached to the frame and configured to process the input audio, the output audio and the video data for the microphone, the at least one audio output device and the at least one infinity optics display.

Additionally, another embodiment of a framed user interface is provided. In this embodiment, the frame user interface includes: (1) a head-mountable frame, (2) only one display attached to the frame, the display including a video projector and a transparent display surface configured to provide a display for the user at a desired frequency of light, (3) at least one audio output device attached to the frame, (4) a microphone attached to the frame, (5) a communication channel interface attached to the frame and configured to transmit and receive audio data associated with the at least one audio output device and the microphone and receive video data associated with the display and (6) an audio and video controller attached to the frame and configured to process the audio and the video data for the at least one audio output device, the microphone and the display.

In yet another aspect, a method of operating an integrated computation and communication system having modular components is provided. In one embodiment, the method includes: (1) receiving input data at a controller from an input apparatus, (2) processing the input data at the controller to generate output data, (3) transmitting the output data from the controller to an output apparatus, the receiving and transmitting via communication channels provided by a communication base station coupled to the controller, the input apparatus and the output apparatus, wherein the controller, the input apparatus, the output apparatus and the communication base station are each unique components of the system and are each adapted to be worn by a user.

### BRIEF DESCRIPTION

Reference is now made to the following descriptions taken in conjunction with the accompanying drawings, in which:

FIG. 1 illustrates is a block diagram of an embodiment of an integrated computation and communication system constructed according to the principles of the disclosure;

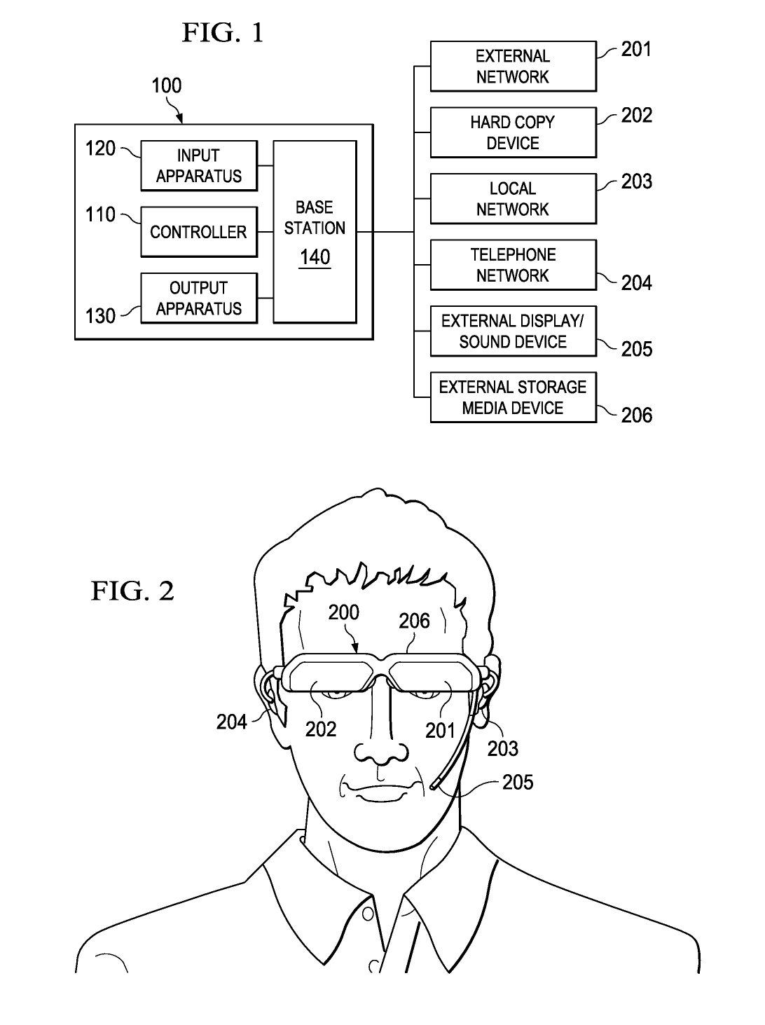

FIG. 2 illustrates a view of an embodiment of a framed user interface constructed according to the principles of the present invention;

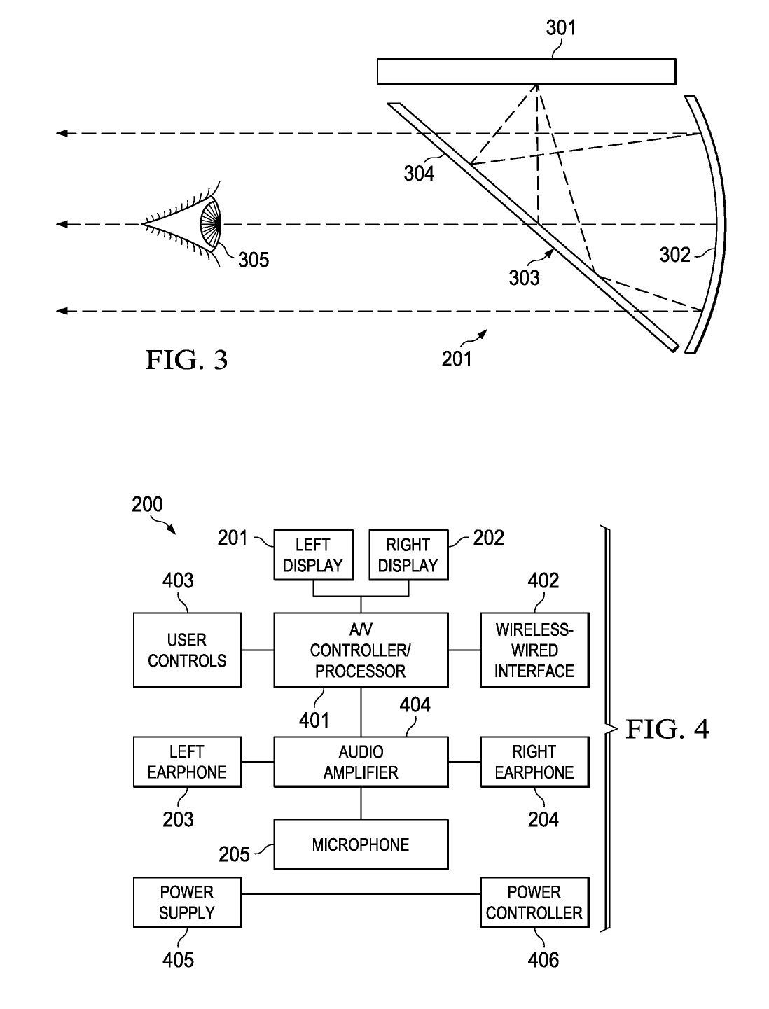

FIG. 3 illustrates the components and a functional schematic operation of the infinity optics displays of the framed user interface of FIG. 2;

FIG. 4 illustrates a block diagram of the framed user interface of FIG. 2 that shows the component and the interrelationship thereof;

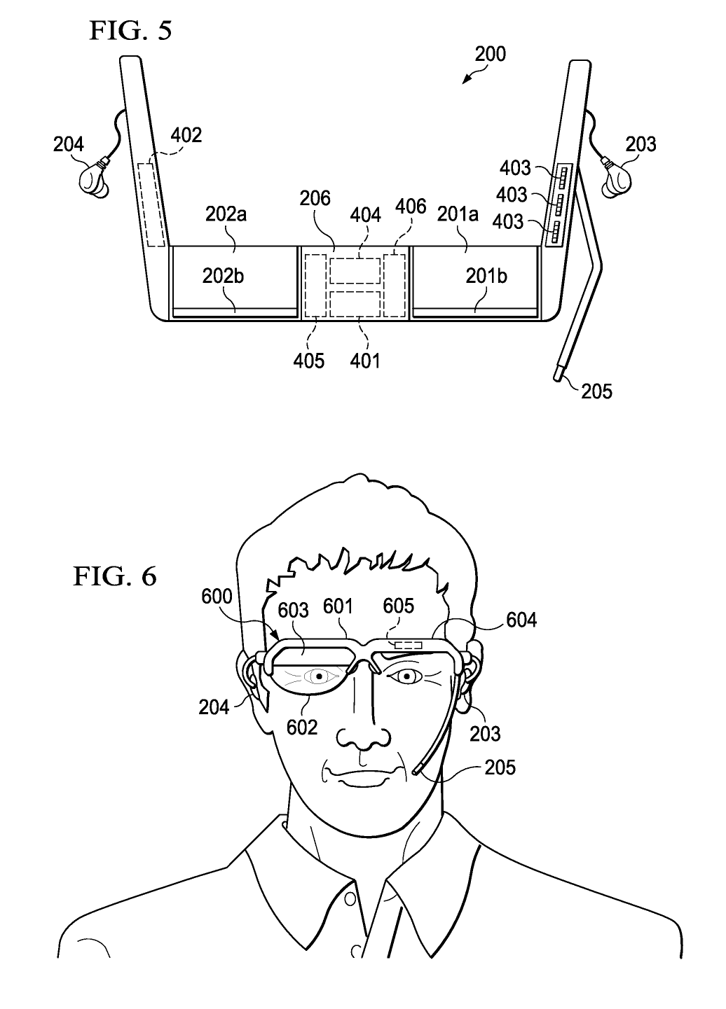

FIG. 5 illustrates a top-view of the framed user interface of FIG. 2 showing the various components as typically located on or in a framed interface structure;

FIG. 6 illustrates a front view of another embodiment of a framed user interface constructed according to the principles of the present invention; and

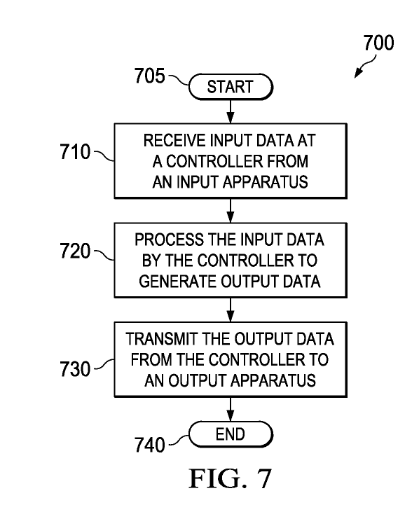

FIG. 7 illustrates an embodiment of a method of operating an integrated computation and communication system having modular components carried out according to the principles of the present invention.

### DETAILED DESCRIPTION

Although a variety of individual components exist to provide computer functionality and communication functionality, the individual components do not provide a fully integrated system, which can provide full functionality in a highly compact, even wearable solution that includes all of the computational, communication and entertainment needs of a user. Accordingly, this disclosure provides a fully functional computation and communication system that is highly portable, modular and yet has fully integrated functionality. The disclosed computation and communication system includes a general purpose computing system that is not only fully functional but is also upgradeable.

Because each of the individual components are wearable by a user without imposing undue restrictions on the user's ability to move or interact, the disclosed system provides enhanced computational and communication capability that can be performed in different environment than fixed office locations. Moreover, the system provides an integrated approach to computation and communication that can provide the ability to simultaneously and seamlessly share information, display information and communicate by voice. In one embodiment, the system also provides the ability to create and manage secure local network communication without intervening hardware or software.

The disclosed system is a small, wearable, highly portable, fully functional information and communication system that provides a fully integrated computational environment. This system includes a controller, an output apparatus, an input apparatus, a communication base station and the software to manage the cooperative performance and communication of the hardware components. The communication base station, the output apparatus and the input apparatus each include the capability of wireless communications to and from the controller using a standard secure protocol and channel. The controller is also provided with the capability of simultaneous communications, using standard wireless communications protocols with one or more networked devices, systems and/or communication networks.

The output apparatus may be a framed user interface that is a wearable audio/video display device adapted for use with computers, video games, and media players. The framed user interface may include multiple components including: one or two infinity optics displays, one or two speaker devices (e.g., earphones), a microphone, a video processor (alternatively an audio/video controller/processor), audio amplifier controller, wireless (and wired) bidirectional communication interface, user controls (e.g., power, reset, volume contrast and brightness controls), a power controller and a rechargeable battery power supply. All of the components are held within or mounted on (i.e., attached) a glasses-like frame device. Through the use of infinity optics, the display system of the framed user interface can reduce eyestrain and enhance a user's perception of a visual scene, while making it possible for the user to easily change the field of view from the display to the user's real-world environment without removing the framed user interface and with limited or no eyestrain.

Turning now to FIG. 1, illustrated is a block diagram of an embodiment of an integrated computation and communication system 100 (i.e., the system 100) constructed according to the principles of the disclosure. The system 100 is a modular system having multiple components that interact together to provide a fully integrated computational and communication environment. The system 100 includes small components that are wearable and highly portable to provide a fully functional information and communication system. The system 100 includes a controller 110, an input apparatus 120, an output apparatus 130, and a communication base station 140. In FIG. 1, the system 100 is illustrated coupled to external devices or networks (denoted as elements 210-206) via the communication base station 140.

The controller 110 is a data storage and computation unit that is configured to provide computational functionality and telephone communication for the system 100. In one embodiment, the controller 110 is capable of operating as a fully functional personal computer, telephone (such as a cellular or satellite telephone), game system, entertainment (video or audio) system and Global Positioning System (GPS) mapping. The controller 110 may include multiple components enabling it to perform multiple functionalities. For example, the controller 110 may include a processor, internal volatile memory, internal non-volatile memory (including such long term storage devices as one or more disk drives, flash memory devices or the like), a wireless transmitter/receiver, a wired transmitter/receiver and a graphics co-processor. The controller 110 may also include a small form factor display and keyboard that is sufficient for start-up initialization, power down, diagnostics and reset functionality. For example, the display and keyboard of the controller 110 may be similar to a display and keyboard of a BlackBerry® telephone from Research In Motion based in Waterloo, Ontario, Canada.

The controller 110 may also include encoders and decoders such as, an encoder/decoder for cellular communication, a sound encoder/decoder and a video decoder. A sound encoder or decoder may comply with the Moving Picture Experts Group (MPEG) standards. The video decoder may be a high resolution decoder capable of decoding 60 Hz or higher video such as, for example, video produced in a Blu-ray compliant player or a high-performance video game system. One skilled in the art will understand that an encoder is a device that converts information from one format or code to another format or code. A decoder reverses the work of an encoder so that the encoded information can be retrieved.

Additionally, the controller 110 may include software, for both an operating system and application programs, to provide full computer functionality. For example, the controller 110 may include a MAC® operating system (e.g., Leopard®), a Windows® operating system (e.g., Windows NT® from Microsoft®) a Linux® operating system or a similar operating system. The controller 110 may also include various application programs that run on the operation systems and perform word, data or image processing, such as Microsoft® Word, Excel®, Access® or Powerpoint®. Additionally, e-mail and browsing programs such as Outlook® and Explorer from Microsoft®, Safari® from MAC® or the like may be installed on the controller 110. The controller 110, therefore, may be a computing device including web browsers, data base and file management and other like and other typical installed generally available software, and other special purpose software, such as system communication software, device diagnostic software, networking (local and wide area) management software, and security encoding/decoding encryption software.

The controller 110 also includes a power supply, including a rechargeable battery and an AC power receptacle and circuitry capable of powering the controller 110. In one embodiment, the controller 110 is also provided with multiple general purpose input or output ports including parallel and serial ports. For example, the controller 110 may include ports for Universal Serial Bus (USB), Firewire® from MAC, audio and video connectors such as Radio Corporation of America (RCA) connectors, and stereo or mono connectors that can be used with a telephone or music players.

The controller 110 is adapted to be wearable by a user. In one embodiment, the controller 110 is or substantially is 4 inches wide, 5 inches long and 1 inch wide. In some embodiments, the controller 110 may even have smaller dimensions. In one embodiment, the controller 110 has a case made of impact resistant material, has heat conductive portions sufficient to dissipate generated heat and is constructed to maintain general water impermeability. The case of the controller 110 may be provided with a clip to attach to, for example, a pocket, a belt or pants of a user. In some embodiments, the controller 110 may be adapted to fit securely within a holster that is worn by the user.

The input apparatus 120 is configured to receive input data from the user. In one embodiment, the input apparatus 120 may be one or a set of data gloves that are adapted to be worn by the user. The data glove or gloves typically include active elements, such as touch or proximity sensors in the fingers and wrist portion, and have a power supply, a rechargeable battery, a processor, a memory, a transmitter and a receiver, located elsewhere, such as, in the wrist region or back-of-hand region of the user. The processor, memory, transmitter and receiver are configured to receive initialization information from the controller 110 and input data from the finger sensors, convert the input data to symbol data for transmitting to the controller 110 and transmit such information, in an encrypted form, to the controller 110. The finger sensors may be touch sensitive and/or location sensitive with respect to the distance from a sensor embedded in the wrist portion. Hand and/or finger keystroke positions can be user programmable. One or more switches may also be provided to facilitate the powering on/off, initialing and/or resetting the data glove or gloves.

The data glove or gloves may be wireless devices so that a user is not physically restricted and able to easily work where it would be difficult for the user to use conventional user interfaces such as a keyboard or a mouse. In other embodiments, the input apparatus 120 may be a type of conventional user interface device, such as a type of mouse, keyboard or touch screen. The touch screen can be a rollable or foldable touch screen device. In one embodiment, the touch screen can be attached to a band to be worn by a user on, for example, a wrist.

The output apparatus 130 is configured to provide output data to the user. As with the input apparatus 120, the output apparatus 120 may be a conventional user interface device, such as a rollable or foldable touch screen device. In some embodiments, the input apparatus 120 and the output apparatus 130 may be a single device.

In one embodiment, the output apparatus 130 may be a framed user interface designed to be light-weight, portable, and to operate via wireless (or alternatively wired) communication channel data. The framed user interface is a display device that may include a head-mountable frame that has one or more infinity optics displays. Additionally, the framed user interface may include audio input and output components, such as, a microphone or one or more speakers or ear phones. The audio input and output components are designed to be compatible with telephone and other audio communications systems as well as music players and entertainment devices, such as MPEG-1 Audio Layer 3 (i.e., MP3), digital video data (DVD), high definition (HD)-DVD, Blu-ray, etc.) player devices.

The infinity optics display or displays of the framed user interface can be sized and located to permit the user to see normally below a displayed image. The framed user interface can also include a transmitter and receiver, a data decoder and a rechargeable battery power supply. One or more switches can also be provided with the framed user interface to facilitate powering on/off, initializing and/or resetting the device. More information regarding framed user interfaces is provided below in FIGS. 2-6.

The communication base station 140 is configured to provide bi-directional communication channels between the various components (i.e., the controller 110, input apparatus 120, the output apparatus 130 and the communication base station 140) of the system 100. The communication base station 140 is a wireless (and wire capable) router/hub that provides an ultra local network used by the system 100 to communicate between the controller 110, the input apparatus 120 and the output apparatus 130; as well as providing the communication channel(s) between the system 100 and external devices or external systems. For example, the external devices or systems may include, but are not necessarily limited to, an external network 201 (such as the Internet); a local network 203 (such as an IEEE 802.11 compliant network); a telephone network 204 (such as, a Plain Old Telephone Service (POTS) network or a cellular network employing, for example, FDMA, DDMA, PDMA, TDMA, 3G and the like); one or more hard copy devices 202 (such as, for example, printers, scanners and the like); external display and/or sound devices 205 (such as, for example, video projectors, panel displays, CRT displays, digital cameras and the like, speaker systems and other like audio components, including recording and playback devices); and one or more external storage/media devices (readers/writers) 206 (such as, for example, magnetic media, flash memory, CD, CD-R, DVD, DVD-R, High Definition DVD, Blu-ray and the like). To facilitate efficient and secure communication, the communication base station 140 typically includes a processor, a memory and an encoder/decoder.

In addition to wired connections, the networks coupled to the system 100 via the communication base station 140 may be coupled via a wireless connection. The local network 203 may include other computation and communication systems. For example, the local network 203 may include other computation and communication systems that are wirelessly connected to the system 100 via the communication base station 140. In one embodiment, at least one of the other computation and communication systems is another integrated computation and communication system. In some embodiments, each of the computation and communication systems is another integrated computation and communication system as described herein.

Through this embodiment of the local network 203, when in a meeting, conference or classroom, each participant can see and interact with a common presentation and can directly communicate, either through voice or text, with one, many or all of the other participants. By employing the external/network 210, the local network 203 can use multiple Internet networked base stations to connect to multiple meetings at remote locations. The networked meetings can allow each participant to directly see and be able to make notes on or interact with their own version of a presentation being given. Additionally, the participants would be able to directly communicate with some or all of the other participants by virtue of their controller (such as a type of controller 110) being locally networked to a base station that is itself Internet networked to other base stations and to other controllers and their respective users therethrough.

In one embodiment, the communication base station 140 also includes an extended rechargeable battery pack for connecting to and operating the other components of the system 110, 120, 130, as necessary. The battery pack may be an extended wired rechargeable battery pack adapted specifically to maintain the operation of the system 100 for extended periods of time. An AC power supply, a plug receptacle, and one or more switches can also be provided with the communication base station to facilitate powering on/off and initializing and/or resetting. Ideally, the communication base station 140 is also a wearable device that has a case made of impact resistant material, with heat conductive portions sufficient to dissipate generated heat, while maintaining general water impermeability. The case of the communication base station 140 may be provided with a clip or may be adapted to fit securely within a holster.

In the illustrated embodiment, the communication base station 140 is provided with the capability to wirelessly and bi-directionally communicate with the other components 110, 120, 130, of the system 100. In an alternative embodiment the communication base station 140 can communicate with the other components 110, 120, 130, of the system 100 in a wired channel. In a further alternative embodiment, the communication base station 140 can selectively communicate with the other components 110, 120, 130, of the system 100 in either a wireless or a wired channel, as appropriate for power management, transfer speed and security. The wireless communication channel can be a Bluetooth® compliant channel, or the like. In one embodiment, the wired channel is a retractable optical fiber that provides a bi-directional channel. Other wireless or wired protocols can also be employed without departing from the concept of this disclosure.

FIG. 2 is an illustration of a view of an embodiment of a framed user interface 200 constructed according to the principles of the present invention. The framed user interface 200 is a display device that may be used as an input apparatus, an output apparatus or both. As illustrated, the framed user interface 200 is configured to be worn by a typical user. The user interface 200 can be used with the computation and communication system 100 of FIG. 1.

The framed user interface 200 includes a first eye display 201 and a second eye display 202, a first 203 and second 204 earphone, a microphone 205 and the associated electronics (not shown in FIG. 2), all attached to a frame 206. The frame 206 is adapted specifically to be conveniently worn in a manner similar to that of eyeglasses (i.e., head-mountable). The first 201 and second 202 eye displays are infinity optic displays, positioned within the frame 206 so as to permit the wearer/user to see into the display by glancing slightly upwards and to permit the wearer/user to otherwise view the real-world environment by glancing slightly downwards. The earphones 203, 204, are adapted and provided with associated electronics to permit their use as stereo audio earphones or as a telephone earpiece or earpiece set. The microphone 205 is adapted and provided with associated electronics to be used as a telephone microphone or audio input device to a computer system, such as the system 100 of FIG. 1. Thus, the microphone 205 and the earphones 203, 204, can be used for audio communications and can be linked to a telephone device such as the controller 110 of FIG. 1. In addition to telephone devices, the earphones 203, 204, can be compatible with music players.

The first and second eye displays 201, 202, can be used to provide a simulated three-dimensional view. The associated electronics can be used to switch a display process to a simulated three-dimensional mode. The user can select a three-dimensional mode via user controls. In the three-dimensional mode, a video controller and processor (part of the associated electronics) can calculate a second “offset” field of view and then present the two field of views, having the appropriate offset for the user eyes, to the separate infinite optics display devices. Instead of calculating, the video controller and processor can employ a pre-photographed field of view to provide the two field of views.

FIG. 3 illustrates the components and a functional schematic operation of the infinity optics displays of the framed user interface 200 (i.e., the first and/or the second eye display 201, 202). In FIG. 3, the first eye display 201 is illustrated to represent the operation of both the first and second displays 201, 202.

The framed user interface 200 may be a “wide angle-collimated” type of display that has been reduced in size and enhanced in capability. Collimation makes use of the principle that by making the light from an image more parallel before it is viewed by an eye 305 of the user makes the image appear to be farther away. This effectively allows the user's eye 305 to focus at “infinity” thereby reducing eye strain by permitting the eye to see the displayed image as though it were at the same distance as the user's real-world (i.e., infinity optics). Information regarding collimation visual displays can be found, for example, in U.S. Pat. No. 5,453,877 to Gerbe, et al., and U.S. Pat. No. 6,944,581 to Creek.

As illustrated, the framed user interface 200 includes a high-resolution image source device 301, typically a Liquid Crystal Display (LCD), a spherical mirror 302, and a beamsplitter 303, which creates the virtual image of the virtual display 304. In alternative embodiments, additional optic components, such as a polarizer, a second beamsplitter, and a quarter wave plate, may be included between the beamsplitter 303 and the user's eye position 305.

FIG. 4 illustrates a block diagram of the framed user interface 200 that shows the components, including the electrical components thereof. FIG. 4 also shows the interrelationship of the components of the framed user interface 200. The first 201 and the second 202 eye displays are shown in electrical communication with an audio/video controller/processor 401. The audio/video controller/processor 401 receives user inputs, such as power on, reset, volume control, video brightness, and contrast controls, via an electrical connection to user controls 403. A wireless and wired interface 402 is provided with a communication channel to the audio/video controller/processor 401. In one embodiment, the wireless interface is a Bluetooth® interface and the wired interface is a high-speed serial interface. Various wireless or wired protocols may be employed for communicating.

An audio amplifier 404 is provided with an electrical communication to the audio/video controller/processor 401. The audio amplifier 404 provides audio processing and controls for the first earphone 203 and the second earphone 204 and processes the received audio input signal from the microphone 205. A power supply 405, typically a rechargeable battery power supply, under the operative control of a power controller 406 provides electrical power to all of the components (110, 120, 401, 402, 401, 404 and 405) of the framed user interface 200.

FIG. 5 illustrates a top-view of the framed user interface 200 showing the various components as typically located on or in a framed interface structure (i.e., attached to). In FIG. 5, the framed user interface 200 includes first eye image source device 201a, a left eye mirror 201b, a second eye image source device 202a and a right eye mirror 202b. The first eye image source device 201a and the second eye image source device 202a (may also be referred to as left and right eye image sources) may be LCD panels.

FIG. 6 illustrates a front view of another embodiment of a framed user interface 600 constructed according to the principles of the present invention. The framed user interface 600 is a monocular display device in the form of a Heads-Up Display (HUD). The HUD-like framed user interface 600 is preferably used with monochromatic display content, such as text and/or simple line drawing graphics. As a HUD-like device, the user interface 600 makes use of a single eye display 601 that includes a transparent display surface 602, a video projector 603 and associated electronics 605 (as described above in relation to FIG. 4) held within a frame 604. The single-eye display 601 may be similar to HUD devices manufactured by Rockwell Collins of Cedar Rapids, Iowa.

Additionally, attached to the frame 604, are the earphones 203, 204, and the microphone 205. The single-eye display 601 is collimated to prevent the user's eye from having to change focus between the outside (“real-world”) and the display of the single-eye display 601. The single-eye display 601 includes a combiner, also described as a transparent display surface 602, a projector unit 603 and image generator electronics 605 which can also be referred to as a video controller/processor. The projector unit 603 may be a miniature LCD projector. The combiner 602 is provided with a coating adapted to specifically reflect light of a particular desired frequency (such as green or red) and to pass the light of all other frequencies. This permits the display of characters and graphics in the desired colors, focused at “infinity” to the user, in front of the outside (real-world) view.

Both the framed user interface 200 and the framed user interface 600 may be employed with a camera system to provide enhanced visual displays for different applications. For example, the visual displays may be used for enhanced reading for the vision impaired. A camera may be wirelessly connected to displays of the framed user interfaces 200 or 600 and photograph printed material in a larger than normal format. The photographed images can then be transmitted to the displays for viewing. In another application in combination with a night vision security system or another video security system, the framed user interfaces 200 or 600 can be used to provide portable remote viewing of wireless networked camera video. Information regarding head-mountable video displays can be found, for example, in U.S. Pat. No. 7,436,568 to Kuykendall, Jr.

Turning now to FIG. 7, illustrated is an embodiment of a method 700 of a method of operating an integrated computation and communication system having modular components carried out according to the principles of the present invention. The computation and communication system may be the system 100 of FIG. 1. The method 700 begins in a step 705.

In a step 710, input data is received by a controller from an input apparatus. The input apparatus may be an data glove or set of gloves worn by a user of the computation and communication system. Alternatively, the input apparatus may be a touch screen device.

The input data is then processed in a step 720 by the controller to generate output data. The controller may employ a stored application program to process the input data and generate the output data. Additionally, the controller may employ other types of stored software such as a web browser or an e-mail application.

The output data is then transmitted from the controller to an output apparatus in a step 730. The output apparatus may be a framed user interface. The output apparatus may also include a microphone that may be used as an input apparatus for receiving audio data. In some embodiments, the output apparatus may be the touch screen device that is also used as the input apparatus.

In the method 700, the receiving and transmitting are via communication channels provided by a communication base station of the computation and communication system. The communication base station is coupled to controller, the input apparatus and the output apparatus via a wired or wireless channel. The controller, the input apparatus, the output apparatus and the communication base station are each unique components of the computation and communication system and are each adapted to be worn by a user. The method 700 ends in a step 740.

Those skilled in the art to which this application relates will appreciate that other and further additions, deletions, substitutions and modifications may be made to the described embodiments.

What is claimed is:

1. An integrated computational and communication system having modular components, comprising:
an input component configured to receive input data from a user;
an output component configured to provide output data to said user;
a controller configured to provide computational functionality and telephone communication for said system; and
a communication base station configured to provide bi-directional communication channels between said input and output components, said communication base station and said controller, wherein said communication base station and said controller are adapted to be worn by said user.

2. The system as recited in claim 1 wherein said input and output components are adapted to be worn by said user.

3. The system as recited in claim 1 wherein said communication base station is further configured to provide a communication channel between said system and an external device.

4. The system as recited in claim 3 wherein said bi-directional communication channels and said communication channel are secure wireless channels.

5. The system as recited in claim 1 wherein said input component is at least one data glove adapted to be worn by said user.

6. The system as recited in claim 1 wherein said output component is a framed user interface having at least one infinity optics display.

7. The system as recited in claim 1 wherein said input component and said output component are a single device.

8. The system as recited in claim 1 wherein said bi-directional communication channels are via retractable optical fibers.

9. The system as recited in claim 1 wherein said bi-directional communication channels employ Bluetooth wireless protocol.

10. The system as recited in claim 3 wherein said communication channel is an IEEE 802.11 compliant channel.

11. A framed user interface, comprising:
a head-mountable frame;
at least one infinity optics display attached to said frame;
at least one audio output device attached to said frame;
a microphone attached to said frame;
a communication channel interface attached to said frame and configured to provide communication channels for transmitting input audio data from said microphone and receiving video data for said at least one infinity optics display and output audio data for said at least one audio output device; and
an audio and video controller attached to said frame and configured to process said input audio, said output audio and said video data for said microphone, said at least one audio output device and said at least one infinity optics display.

12. The framed user interface as recited in claim 11 wherein said communication channel interface is a wireless interface.

13. The framed user interface as recited in claim 11 wherein said communication channel interface is configured to utilize said microphone for audio communication via a telephone network.

14. The framed user interface as recited in claim 11 wherein said at least one audio output device is an earpiece.

15. The framed user interface as recited in claim 11 having two infinity optics displays attached to said frame.

16. The framed user interface as recited in claim 15 wherein said audio and video processor is configured to provide a simulated three-dimensional view employing said two infinity optics displays.

17. A framed user interface, comprising:
a head-mountable frame;
only one display attached to said frame, said display including a video projector and a transparent display surface configured to provide a display for said user at a desired frequency of light;
at least one audio output device attached to said frame;
a microphone attached to said frame;
a communication channel interface attached to said frame and configured to transmit and receive audio data associated with said at least one audio output device and said microphone and receive video data associated with said display; and
an audio and video controller attached to said frame and configured to process said audio and said video data for said at least one audio output device, said microphone and said display.

18. The framed user interface as recited in claim 17 wherein said transparent display surface includes a reflective coating configured to reflect light of said desired frequency.

19. The framed user interface as recited in claim 17 wherein said communication channel interface is a wireless interface.

20. The framed user interface as recited in claim 17 wherein said communication channel interface is configured to utilize said microphone for audio communication via a telephone network.

21. A method of operating an integrated computation and communication system having modular components, comprising:
receiving input data at a controller from an input apparatus;
processing said input data at said controller to generate output data; and
transmitting said output data from said controller to an output apparatus, said receiving and transmitting via communication channels provided by a communication base station coupled to said controller, said input apparatus and said output apparatus, wherein said controller, said input apparatus, said output apparatus and said communication base station are each unique components of said system and are each adapted to be worn by a user.
